(19) United States
(12) Patent Application Publication
(10) Pub. No.: US 2016/0351037 A1
(43) Pub. Date: Dec. 1, 2016

(54) Child Car Heatstroke Alarm and Prevention System (CHARM)

(71) Applicants: Elaine Tianjiao Yang, Portland, OR (US); Andrew Tianxing Yang, Portland, OR (US)

(72) Inventors: Elaine Tianjiao Yang, Portland, OR (US); Andrew Tianxing Yang, Portland, OR (US)

(21) Appl. No.: 14/724,979

(22) Filed: May 29, 2015

(51) Int. Cl. G08B 21/02

(52) U.S. Cl. CPC G08B 21/02

(57) ABSTRACT

Our invention CHARM for preventing children from being left behind in a car has the potential to dramatically reduce the number of heat stroke deaths. The invention leverages emerging high technologies (such as sensors for accelerometer and temperature, Arduino microcontroller) and a circuit board in connection with car monitor and control system (such as panic alarm and door system) to detect if a child is left behind in a car and send out an alarm.

### TECHNICAL FIELD

This invention belongs to an electronics device and system field.

### BACKGROUND

On average, 38 children die in trapped cars every year in the US [1]. Furthermore, 14% of parents have left their children in hot cars at some point. The inside of a car can reach 125° F. within 25 minutes even when the outside is 90° F. Previous attempts by companies such as GM, NASA, and Ford have been ineffective.

Previous attempts failed to accurately detect whether a child is left in a stopped car for a dangerous amount of time. They also failed to provide a reliable solution to save the child in a critical situation.

These were no accurate ways to detect whether a child is left in the parked car for an extended period, which lead to false alarm or failure to detect.

They also rely on some method to notify parents and/or police as a way to save a child through cellular, Bluetooth or WIFI. These are not effective as parents might not get the notification (e.g. without the phone), or it is too late to save the trapped child even if a notification is received.

### BRIEF SUMMARY OF THE INVENTION AND ITS ADVANTAGES EFFECTS

Our invention CHARM for preventing children from being left behind in a car uses (1) a pressure sensor to detect whether the child is on board, (2) an accelerometer to detect whether the car is parked, (3) a temperature sensor to detect the dangerously hot or cold temperature, (4) integration of a car remote to trigger the car panic alarm, and open the door when temperature is dangerously high, (5) an Arduino microcontroller to control all of the components above.

This invention improves upon prior arts due to the following three mechanisms.
1) An accelerometer measures the scale and amount of vertical vibration to detect if car is stopped. It combines with timers and pressure and temperature sensors to provide an accurate indication on if a child is left in the car in a dangerous situation.
2) A microcontroller allows adjustment of parameters and extension of the system with new functions.
3) The integration with the car protection system, such as panic alarm and remote controlled door opener to save child in time-critical situation.

### BRIEF DESCRIPTION OF THE DRAWING

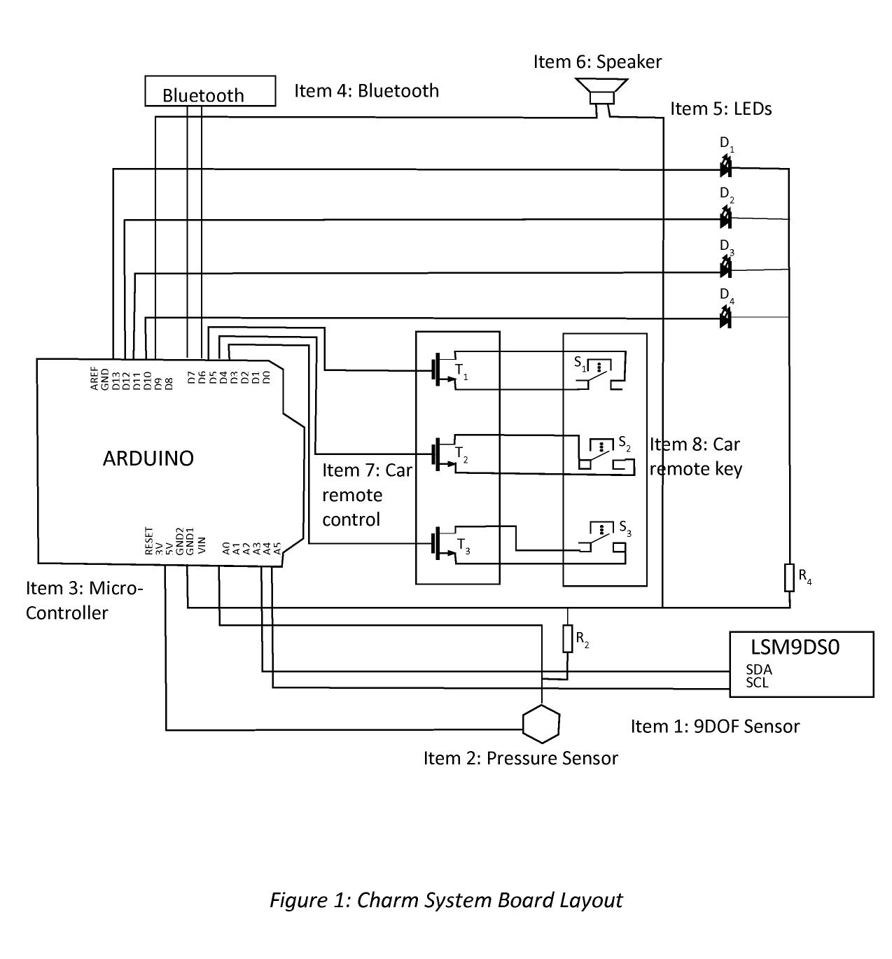

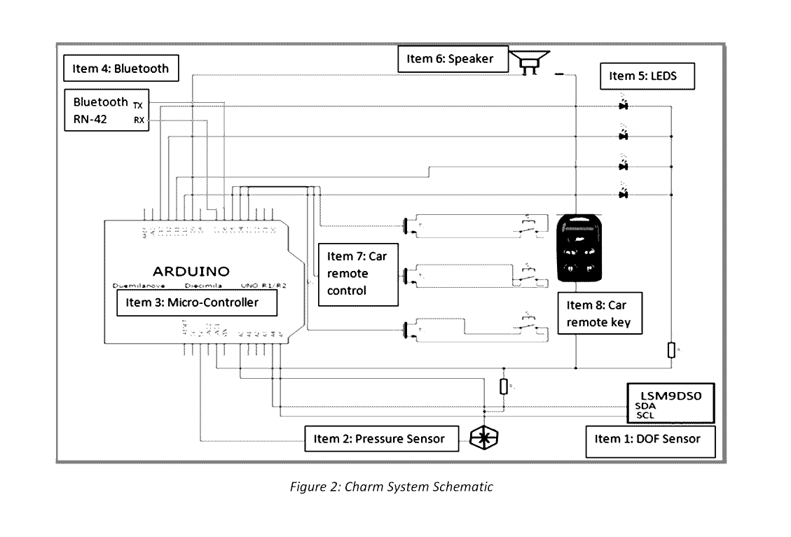

FIG. 1 illustrates a schematic layout of the invention. The list of components in the figure that made up the invention is the following.
Item 1. DOF (Degree of Freedom) sensor with integrated temperature sensor
Item 2. Pressure sensor
Item 3. Micro-controller such as Arduino, Edison
Item 4. Bluetooth module
Item 5. LEDs
Item 6. Speaker
Item 7. Car remote control circuit
Item 8. Car remote key

The relationship between the components is the following.

The 9DOF sensor (item 1) and the pressure sensor (item 2) are connected to the micro-controller (item 3) as input devices. The 9DOF sensor (item 1) can be replaced by a standalone accelerometer and a temperature sensor. All these sensors can be replaced by other sensors with similar functionality.

The Bluetooth module (item 4), the LEDs (item 5), the speaker (item 6) and the car remote control circuit (item 7) are connected to the micro-controller (item 3) as output devices. Item 4 can be replaced by other signal transmission devices such as WIFI or cellular. Item 5 and 6 can be replaced by any other alarming devices.

In addition, the car remote control circuit (item 7) is connected to the car remote key (item 8). Item 8 can be replaced by any access mechanism to a car control system.

### DETAILED DESCRIPTION OF THE INVENTION

### The Invention Works as Follows

The micro-controller (item 3) periodically reads values from the accelerometer and the temperature sensor (9DOF sensor, item 1) and the pressure sensor (item 2).

The readings from the accelerometer measures the amount of vibrations as measured by the changes in acceleration caused by a running engine and car. When the car stops completely, the change in acceleration will be zero within a noise error bound.

The readings from the temperature sensor measures the real time temperature in the car.

The readings from the pressure sensor measures the weight of the object on a car seat. It is tuned to detect if a child is placed on the car seat.

Based on these readings, the micro-controller (item 3) triggers alarm and prevention mechanism depending on how long certain conditions hold.

When the car stops completely and the child is on the car seat for certain amount of time, the warning system (item 5 and item 6) will be triggered.

If this condition continues to exist for an additional time, the car panic alarm will be triggered (item 7 and 8). If the temperature in the car exceeds a safety threshold, the car door will be opened automatically when possible.

In addition, the Bluetooth module uses its LE (Low Energy) mode to send out beacon signals, and the corresponding beacon detection app is installed on the driver's phone.

When the driver is away from the car and loses the signal, the app will trigger the alarm on the phone to make the driver aware.

### The Invention is Made in the Following Way.

There are three stages to put the invention together: Stage 1—hardware, Stage 2—micro-controller (Arduino) software, and Stage 3—phone application.

### Stage 1. Hardware.

Step 1. The accelerometer (e.g., The LSM9DS0 breakout) is connected to an Arduino (e.g., an UNO board) through I2C interface (VDD, GND, SCL and SDA). More specifically, the power (VDD). An alternative is SPI.
Step 2. The pressure sensor (e.g., the Flexiforce Pressure Censor by Sparkfun) is connected to Arduino through analog pins. More specifically, one end is connected to 5V VDD on Arduino, and the other end to a resistor then to GND and also to an analog pin on Arduino.
Step 3. The positive ends of the speaker and LEDS are connected to digital pins on Arduino, and the negative ends to GND.
Step 4. The gates of three transistors are connected to the digital pins on Arduino. The source/drain pairs of the transistors serve as digital relays for the panic alarm, car unlock and door opener on a car remote circuit.

### Stage 2. Arduino Software.

Step 1. Use timers t_pre, t_accel to track how long the child is on the car seat and how long the car has stopped.
Step 2. Initialize the system.
Step 3. Periodically (e.g., 0.5 seconds) does the following:
Step 3.1. Increment both timers.
Step 3.2. Read pressure sensor. If the reading indicates a child is not on the car seat, reset t_pres.
Step 3.3. Read the accelerometer. If last 20 values indicate engine is running, reset t_accel.
Step 3.4. Set high (based on severity of the situation) to the pins to speakers, LEDs, car remote panic alarm, unlock and door open.
Step 3.5. Send the beacon through Bluetooth LE module.
   Stage 3. Phone Application to Detect the Beacon Signal and Set Alarm when the Signal is Lost.

A pressure sensor, an accelerometer, a temperature sensor and a micro-controller are necessary. The control circuit for the car remote is necessary. The speaker and LEDS can be optional. The Bluetooth LE is optional but good to have to warn parents who left the car. The control circuit to the car remote can be replaced by more sophisticated means to connect to a car vehicle control system when possible.

The pins to connect various components can be changed and reconfigured. The accelerometer can be configured to use SPI interface. The steps in program flow can be changed as long as it does the read first and then take actions.

### The Invention is Used in the Following Way.

The system is powered by a battery and attached to the side of a child car seat with the pressure sensor on top of the seat. The system is turned-on when the seat belt is buckled. The remote key needs to be preset to work with the specific model of the car.

### Other Invention Uses and Industry Applicability

Although the invention describes a stand-alone device, the functionalities can be integrated into the car control system as the car control system is getting more and more sophisticated. For instance, only the pressure sensor is a part of the car seat, and the rest can use existing sensors (such as temperature sensor, direct way to detect if engine is running) and the micro-controller in the car. The circuit to control the car doors and the alarm can be directly controlled by the micro-controller.

### REFERENCES

[1] Jan Null, CCM, Heatstroke Deaths of Children in Vehicles, Department of Meteorology and Climate Science, San Jose State University (website: http://www.ggweather.com/heat/), Updated May 15, 2015. Also published in Pediatrics 2005, 116; e109

What is claimed is:

1. Our invention CHARM for preventing children from being left behind in a car uses (1) a pressure sensor to detect whether the child is on board, (2) an accelerometer to detect whether the car is parked, (3) a temperature sensor to detect the dangerously hot or cold temperature, (4) integration of a car remote key to trigger the car panic alarm, and open the door when temperature is dangerously high or low, (5) an Arduino microcontroller to control all of the components above.

2. The invention CHARM of claim 1, wherein said accelerometer measures the scale and amount of vertical vibration to detect if the car is stopped. It combines with timers and pressure and temperature sensors to provide an accurate indication on if a child is left in the car in a dangerous situation.

3. The invention CHARM of claim 1, wherein said microcontroller allows adjustment of parameters and extension of the system with new functions.

4. The invention CHARM of claim 1, wherein integrates with the car protection system, such as panic alarm and remote controlled door opener to save child in time-critical situation.

5. The invention CHARM of claim 1, wherein the 9DOF sensor and the pressure sensor are connected to the micro-controller as input devices. The 9DOF sensor can be replaced by a standalone accelerometer and a temperature sensor. All of these sensors can be replaced by other sensors with similar functionality.

6. The invention CHARM of claim 1, wherein the Bluetooth module, the LEDs, the speaker and the car remote control circuit are connected to the micro-controller as output devices. The Bluetooth module can be replaced by other signal transmission devices such as WIFI or cellular. The LEDs and the speaker can be replaced by any other alarming devices.

7. The invention CHARM of claim 1, wherein the car remote control circuit is connected to the car remote key. The car remote key can be replaced by any access mechanism to a car control system.

8. The invention CHARM of claim 1, wherein the working program is: The micro-controller periodically reads values from the accelerometer and the temperature sensor (9DOF sensor) and the pressure sensor.

9. The invention CHARM of claim 1, wherein the working program is: The readings from the accelerometer measures the amount of vibrations as measured by the changes in acceleration caused by a running engine and car. When the car stops completely, the change in acceleration will be zero within a noise error bound.

10. The invention CHARM of claim 1, wherein the working program is: The readings from the temperature sensor measures the real time temperature in the car.

11. The invention CHARM of claim 1, wherein the working program is: The readings from the pressure sensor measures the weight of the object on a car seat. It is tuned to detect if a child is placed on the car seat.

12. The invention CHARM of claim 1, wherein the working program is: Based on these readings, the micro-controller triggers alarm and prevention mechanism depending on how long certain conditions hold.

13. The invention CHARM of claim 1, wherein the working program is: When the car stops completely and the child is on the car seat for certain amount of time, the warning system (the LEDs and the speakers) will be triggered.

14. The invention CHARM of claim 1, wherein the working program is: If this condition continues to exist for an additional time, the car panic alarm will be triggered (car remote control circuit and car remote key). If the temperature in the car exceeds a safety threshold, the car door will be opened automatically when possible.

15. The invention CHARM of claim 1, wherein the working program is: The Bluetooth module uses its LE (Low Energy) mode to send out beacon signals, and the corresponding beacon detection app is installed on the driver's phone. When the driver is away from the car and loses the signal, the app will trigger the alarm on the phone to make the driver aware.

16. The invention CHARM of claim 1, wherein the system is powered by a battery and attached to the side of a child car seat with the pressure sensor on top of the seat. The system is turned-on when the seat belt is buckled. The remote key needs to be preset to work with the specific model of the car.

17. The invention CHARM of claim 1, wherein although the invention describes a stand-alone device, the functionalities can be integrated into the car control system as the car control system is getting more and more sophisticated. For instance, only the pressure sensor is a part of the car seat, and the rest can use existing sensors (such as temperature sensor, direct way to detect if engine is running) and the micro-controller in the car. The circuit to control the car doors and the alarm can be directly controlled by the micro-controller.
